(19) United States
(12) Patent Application Publication
(10) Pub. No.: US 2026/0238984 A1
(43) Pub. Date: Aug. 13, 2026

(54) SYSTEM AND METHOD FOR CONVERTING A FIXED WIRED DEVICE INTO A VIRTUAL WIRELESS DEVICE USING AN ESIM PROXY DEVICE

(71) Applicant: Boost SubscriberCo L.L.C., Englewood, CO (US)

(72) Inventor: Dale Drew, Arvada, CO (US)

(21) Appl. No.: 19/052,147

(22) Filed: Feb. 12, 2025

(51) Int. Cl. H04W 8/18; H04L 45/74; H04W 60/00

(52) U.S. Cl. CPC H04W 8/18; H04L 45/74; H04W 60/00

(57) ABSTRACT

Embodiments are directed towards systems and methods for providing fixed wired connection to a Radio Access Network using an eSIM proxy device. The method includes: connecting a network wired device on a fixed wired network to an electronic Subscriber Identity Module (eSIM) proxy device; converting, via the eSIM proxy device, the IP address of the network wired device into an eSIM that includes eSIM configuration data; registering the eSIM of the network wired device with a 5G wireless network; routing transmissions from the network wired device into the 5G wireless network using the eSIM configuration data as standard SIM configuration data to handle 5G wireless protocol actions for the network wired device; and enabling the network wired device on the fixed wired network, via the eSIM proxy device, to use SIM protocols to orchestrate native 5G wireless network functions on the network wired device.

### BACKGROUND

Data between User Equipment and a network may travel through various components along the data path in a cellular network. In most cases, the resource allocation and the data path is configured statically or semi-statically. A specific set of parameters assigned for the User Equipment is called a network slice. A network slice is a logical end-to-end network that is created dynamically, and which is optimized for a specific User Equipment or use cases. A user equipment (UE) can access multiple slices over one access network, such as over the same radio interface.

For example, in a 5G network there are network slices that are associated with various functions, such as security functions. When a customer connects into its own network, slice orchestration may be used to route the customer to the appropriate network slice using network slice IDs. In this manner, the customer receives native access to the appropriate c inside its own wireless network.

While this technique works well within a customer's wireless network, there is currently no analogous solution for when customers route through a fixed wire connection to the Internet. Such an Internet based connection is typically unsecure with no native features and functions, such as security functions. It is with respect to these and other considerations that the embodiments described herein have been made.

### BRIEF SUMMARY

The present disclosure relates generally to telecommunication networks, more particularly, to the system and method of fixed wired connection to eSIM proxy device. Briefly stated, one or more methods of converting a fixed wired device into a virtual wireless end user device on a Radio Access Network are disclosed. Some such methods include: connecting a network wired device on a fixed wired network to an electronic Subscriber Identity Module (eSIM) proxy device; converting, via the eSIM proxy device, the IP address of the network wired device into an eSIM that includes eSIM configuration data; registering the eSIM of the network wired device with a 5G wireless network; routing transmissions from the network wired device into the 5G wireless network using the eSIM configuration data as standard SIM configuration data to handle 5G wireless protocol actions for the network wired device; and enabling the network wired device on the fixed wired network, via the eSIM proxy device, to use SIM protocols to orchestrate native 5G wireless network functions on the network wired device.

In one or more embodiments of the method for converting a fixed wired device into a virtual wireless end user device, the operation of orchestrating native 5G wireless network functions on the network wired device further comprises: controlling access of the Radio Access Network, via the eSIM proxy device, using SIM protocols. In another aspect of some embodiments, the operation of orchestrating native 5G wireless network functions on the network wired device further comprises: controlling session encryption of the Radio Access Network, via the eSIM proxy device, using SIM protocols. In still another aspect of some embodiments, the operation of orchestrating native 5G wireless network functions on the network wired device further comprises: controlling mobile edge compute capability, via the eSIM proxy device, using SIM protocols. In yet another aspect of some embodiments, the operation of orchestrating native 5G wireless network functions on the network wired device further comprises: controlling zero trust technology to provide security endpoint protection, via the eSIM proxy device, using SIM protocols.

In some embodiments of the method for converting a fixed wired device into a virtual wireless end user device, the orchestration of the native wireless network functions on the network wired device further includes: enabling communication with the network wired device, via the eSIM proxy device, only over the wireless network; and preventing Internet-based communication with the network wired device. In another aspect of some embodiments, the fixed wired device connects via the eSIM to a 5G network slice without connecting to a public internet, and wherein communications are secured by enabling authorized communications only through the 5G network slice, and prohibiting authorized communications outside of the 5G network slice. In still another aspect of some embodiments, the wherein the fixed wired device is an Internet of Things (IoT) device, and wherein the IoT device is registered with an eSIM using an Integrated Circuit Card Identification (ICCID) number. In yet another aspect of some embodiments, the method further comprises: uploading device IDs of fixed wired devices in a bulk batch; batch processing the device IDs of the fixed wired devices in the bulk batch; and creating eSIMs for the fixed wired devices in the bulk batch.

In other embodiments, a system for converting a fixed wired device into a virtual wireless end user device on a Radio Access Network are disclosed. The system includes a memory that stores computer-executable instructions; and a processor that executes the computer-executable instructions that cause the processor to: connect a network wired device on a fixed wired network to an electronic Subscriber Identity Module (eSIM) proxy device; convert, via the eSIM proxy device, the IP address of the network wired device into an eSIM that includes eSIM configuration data; register the eSIM of the network wired device with a 5G wireless network; route transmissions from the network wired device into the 5G wireless network using the eSIM configuration data as standard SIM configuration data to handle 5G wireless protocol actions for the network wired device; and enable the network wired device on the fixed wired network, via the eSIM proxy device, to use SIM protocols to orchestrate native 5G wireless network functions on the network wired device.

In one or more embodiments of the system for converting a fixed wired device into a virtual wireless end user device, the orchestration of the native 5G wireless network functions on the network wired device further includes access control of the Radio Access Network, via the eSIM proxy device, using SIM protocols. In another aspect of some embodiments, the orchestration of the native 5G wireless network functions on the network wired device further includes session encryption control of the Radio Access Network, via the eSIM proxy device, using SIM protocols. In still another aspect of some embodiments, the orchestration of the native 5G wireless network functions on the network wired device further includes mobile edge compute capability control, via the eSIM proxy device, using SIM protocols. In yet another aspect of some embodiments, the orchestration of the native 5G wireless network functions on the network wired device further includes zero trust technology control to provide security endpoint protection, via the eSIM proxy device, using SIM protocols.

In some embodiments of the system for converting a fixed wired device into a virtual wireless end user device, the orchestration of the native wireless network functions on the network wired device further includes: enabling communication with the network wired device, via the eSIM proxy device, only over the wireless network; and preventing Internet-based communication with the network wired device. In another aspect of some embodiments, the fixed wired device connects via the eSIM to a 5G network slice without connecting to a public internet, and wherein communications are secured by enabling authorized communications only through the 5G network slice, and prohibiting authorized communications outside of the 5G network slice. In still another aspect of some embodiments, the fixed wired device is an Internet of Things (IoT) device, and wherein the IoT device is registered with an eSIM using an Integrated Circuit Card Identification (ICCID) number. In yet another aspect of some embodiments, the system uploads device IDs of fixed wired devices in a bulk batch, batch processes the device IDs of the fixed wired devices in the bulk batch, and creates eSIMs for the fixed wired devices in the bulk batch.

In still other embodiments, a non-transitory computer-readable storage medium is disclosed. The non-transitory computer-readable storage medium has computer-executable instructions stored thereon that, when executed by a processor, cause the processor to: convert, via an electronic Subscriber Identity Module (eSIM) proxy device, an IP address of a network wired device into an eSIM that includes eSIM configuration data; register the eSIM of the network wired device with a 5G wireless network; route transmissions from the network wired device into the 5G wireless network using the eSIM configuration data as standard SIM configuration data to handle 5G wireless protocol actions for the network wired device; and enable the network wired device on the fixed wired network, via the eSIM proxy device, to use SIM protocols to orchestrate native 5G wireless network functions on the network wired device.

In one or more embodiments of the non-transitory computer-readable storage medium, the orchestration of the native 5G wireless network functions on the network wired device further includes access control of the Radio Access Network, via the eSIM proxy device, using SIM protocols. In another aspect of some embodiments, the orchestration of the native 5G wireless network functions on the network wired device further includes session encryption control of the Radio Access Network, via the eSIM proxy device, using SIM protocols. In still another aspect of some embodiments, the orchestration of the native 5G wireless network functions on the network wired device further includes mobile edge compute capability control, via the eSIM proxy device, using SIM protocols. In yet another aspect of some embodiments, the orchestration of the native 5G wireless network functions on the network wired device further includes zero trust technology control to provide security endpoint protection, via the eSIM proxy device, using SIM protocols.

In some embodiments of the non-transitory computer-readable storage medium, the orchestration of the native wireless network functions on the network wired device further includes: enabling communication with the network wired device, via the eSIM proxy device, only over the wireless network; and preventing Internet-based communication with the network wired device. In another aspect of some embodiments, the fixed wired device connects via the eSIM to a 5G network slice without connecting to a public internet, and wherein communications are secured by enabling authorized communications only through the 5G network slice, and prohibiting authorized communications outside of the 5G network slice. In still another aspect of some embodiments, the fixed wired device is an Internet of Things (IoT) device, and wherein the IoT device is registered with an eSIM using an Integrated Circuit Card Identification (ICCID) number. In yet another aspect of some embodiments, the system uploads device IDs of fixed wired devices in a bulk batch, batch processes the device IDs of the fixed wired devices in the bulk batch, and creates eSIMs for the fixed wired devices in the bulk batch.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the disclosed invention, reference will be made to the following Detailed Description, which is to be read in association with the accompanying drawings.

FIG. 1 illustrates a context diagram of an environment in which a system for a fixed wired connection to e-SIM proxy device may be implemented in accordance with embodiments described herein.

FIG. 2 illustrates a diagram of an example system architecture overview of a system in which the environment of FIG. 1 may be implemented in accordance with embodiments described herein.

FIG. 3 illustrates a diagram showing connectivity between certain telecommunication network components during cellular telecommunication.

FIG. 4 illustrates a legacy communication flow within a system from a desktop computer to the Internet via Dedicated Internet Access (DIA).

FIG. 5 illustrates a communication flow within a system for a fixed wired connection from a desktop computer to a 5G Core via an e-SIM proxy device.

FIG. 6 illustrates a communication flow within a system for a fixed wired connection from an Internet of Things (IoT) device to a 5G Core via an e-SIM proxy device.

FIG. 7 is a logic diagram showing a method for a fixed wired connection to e-SIM proxy device.

FIG. 8 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments of a Fixed Wired Connection To A Wireless Core via an e-SIM Proxy Device. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

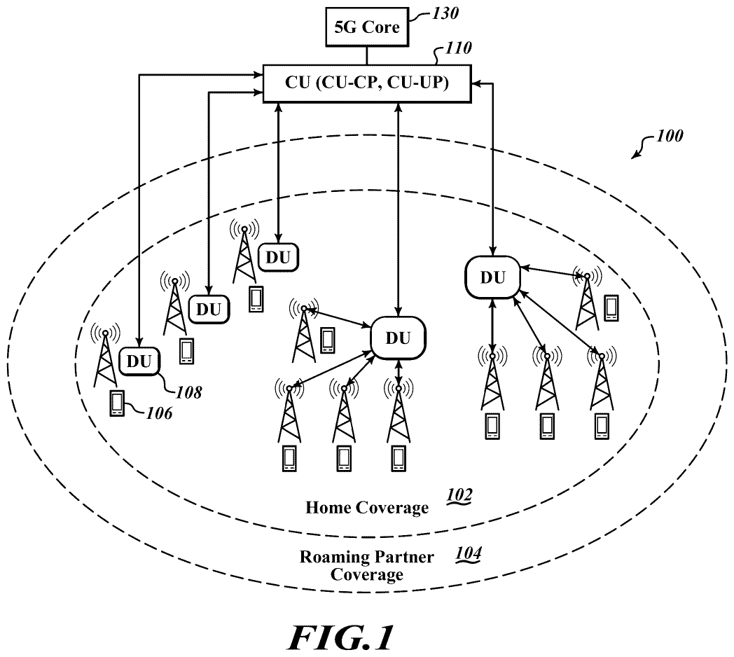

FIGS. 1-3 illustrate various aspects of a 5G environment that is described below with respect to a system for converting a fixed wired device into a virtual wireless device using an eSIM proxy device in O-RAN in a cellular network. An electronic Subscriber Identity Module (eSIM) is a virtual SIM that can be set up with a wireless connection. In contrast, a physical SIM card is a small chip that is inserted into a phone or other networked device 106 to connect to a carrier's network and a 5G Core 130. While virtual SIMs have been traditionally set up with a Wi-Fi connection, which is Internet based, in the disclosed embodiments discussed herein, virtual SIMs are being set up with a 5G network slice connection to a 5G Core 130 that is separate from the Internet. In other embodiments, virtual SIMs are being set up with a 6G (or higher) network slice connection to a 6G (or higher) Core that is separate from the Internet.

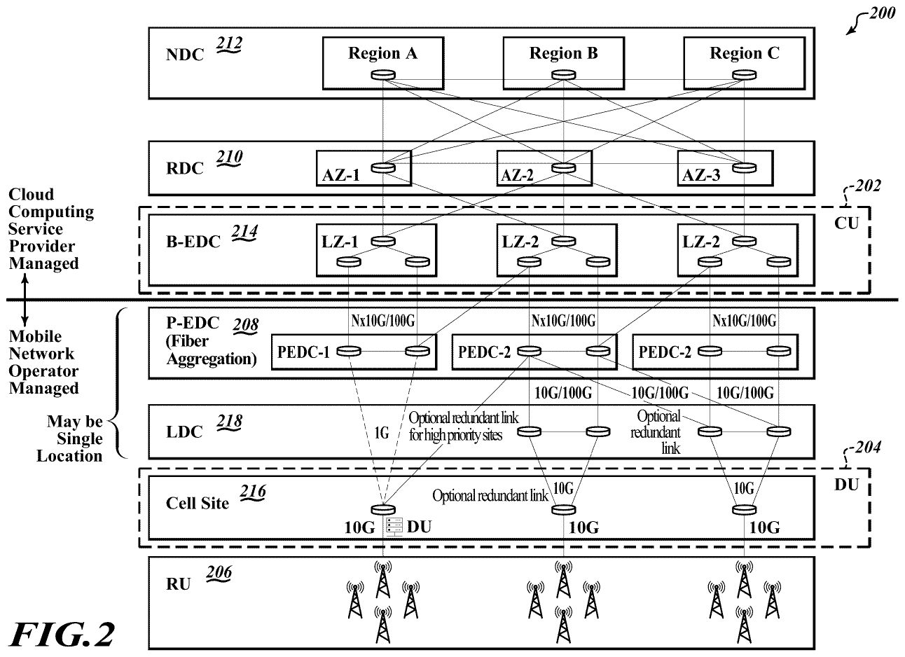

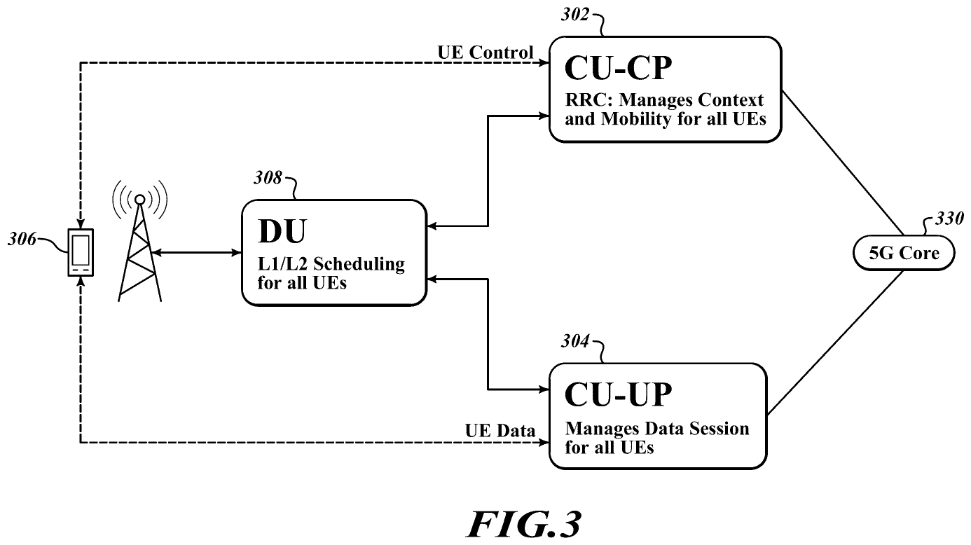

For example, FIG. 1 illustrates a context diagram of connects between a 5G Core 130, CUs (Centralized Units) 110, DUs (Distributed Units) 108, and UEs (User Equipment) 106. FIG. 2 illustrates a diagram of an example system architecture overview that includes an NDC (National Data Center), RDC (Regional Data Center), B-EDC (Breakout Edge Data Centers), P-EDC (Passthrough Edge Data Centers), LDC (Local Data Center), cell sites, and RUs (Radio Units). FIG. 3 illustrates a diagram showing UE controls for managing context and mobility for UEs 306 and UE data for managing data session of UEs with a 5G Core 330.

Advanced cellular networks provide a broad range of wireless services delivered to the end user across multiple access platforms and multi-layer networks. For example, 5G is a dynamic, coherent and flexible framework of multiple advanced technologies supporting a variety of applications. 5G utilizes an intelligent architecture, with Radio Access Networks (RANs) not constrained by base station proximity or complex infrastructure. 5G enables a disaggregated, flexible, and virtual RAN with interfaces creating additional data access points. 5G network functions may be completely software-based and designed as cloud-native, meaning that they are agnostic to the underlying cloud infrastructure, allowing higher deployment agility and flexibility. With the advent of 5G, industry experts defined how the 5G Core 130 (5GC) network should evolve to support the needs of 5G New Radio (NR) and the advanced use cases enabled by it. The 3rd Generation Partnership Project (3GPP) develops protocols and standards for telecommunication technologies including RAN, core transport networks and service capabilities. 3GPP has provided complete system specifications for 5G network architecture which is much more service oriented than previous generations. Future network architectures, such as 6G and others, are expected to utilize many of these features and functionalities.

Multi-Access Edge Computing (MEC) is an important element of 5G architecture. MEC is an evolution in telecommunications that brings the applications from centralized data centers to the network edge, and therefore closer to the end users and their devices. This essentially creates a shortcut in content delivery between the user and host, and the long network path that once separated them.

This MEC technology is not exclusive to 5G but is certainly important to its efficiency. Characteristics of the MEC include the low latency, high bandwidth and real time access to RAN information that distinguishes 5G architecture from its predecessors. This convergence of the RAN and core networks enables operators to leverage new approaches to network testing and validation. 5G networks based on the 3GPP 5G specifications provide an environment for MEC deployment. The 5G specifications define the enablers for edge computing, allowing MEC and 5G to collaboratively route traffic. In addition to the latency and bandwidth benefits of the MEC architecture, the distribution of computing power better enables the high volume of connected devices inherent to 5G deployment and the rise of IoT.

A virtual private cloud (VPC) is a configurable pool of shared resources allocated within a public cloud environment. The VPC provides isolation between one VPC user and all other users of the same cloud, for example, by allocation of a private IP subnet and a virtual communication construct (e.g., a VLAN or a set of encrypted communication channels) per user. In some embodiments, this 5G network leverages the distributed nature of 5G cloud-native network functions and cloud flexibility, which optimizes the placement of 5G network functions for optimal performance based on latency, throughput and processing requirements.

The 3rd Generation Partnership Project (3GPP) develops protocols for mobile telecommunications and has developed a standard for 5G. The 5G architecture is based on what is called a Service-Based Architecture (SBA), which leverages IT development principles and a cloud-native design approach. In this architecture, each network function (NF) offers one or more services to other NFs via Application Programming Interfaces (API). Network function virtualization (NFV) decouples software from hardware by replacing various network functions such as firewalls, load balancers and routers with virtualized instances running as software. This eliminates the need to invest in many expensive hardware elements and can also accelerate installation times, thereby providing revenue generating services to the customer faster.

NFV enables the 5G infrastructure by virtualizing appliances within the 5G network. This includes the network slicing technology that enables multiple virtual networks to run simultaneously. NFV may address other 5G challenges through virtualized computing, storage, and network resources that are customized based on the applications and customer segments. The concept of NFV extends to the RAN through, for example, network disaggregation promoted by alliances such as O-RAN. This enables flexibility and provides open interfaces and open-source development, ultimately to ease the deployment of new features and technology with scale. The O-RAN ALLIANCE objective is to allow multi-vendor deployment with off-the shelf hardware for the purposes of easier and faster inter-operability. Network disaggregation also allows components of the network to be virtualized, providing a means to scale and improve user experience as capacity grows. The benefits of virtualizing components of the RAN provide a means to be more cost effective from a hardware and software viewpoint especially for IoT applications where the number of devices is in the millions.

Open RAN disaggregates traditional monolithic, single-vendor radio access networks (RAN) into a distributed unit (DU), centralized unit (CU) and radio unit (RU) and connects these elements using open standard interfaces. Disaggregation allows the operator to virtualize the CU and DU components and run them on commercial off the shelf (COTS) servers using a fully virtualized, cloud-native Open RAN network. The radio unit (RU) is connected to the DU through an open interface. In this way Open RAN networks can be built using interchangeable systems from a competitive Open RAN ecosystem.

Open RAN puts the mobile network operator (MNO) in control of their network with more transparency, technology choice and competition, resulting in lower costs and more agile networks. Open RAN constitutes a radical transformation of the RAN technology with a new Open RAN architecture and a broad and deep Open RAN ecosystem of companies that provide new Open RAN 4G and 5G networks that are flexible, cost-effective and innovative.

The RAN provides wireless connectivity to mobile users, providing connectivity and converts radio frequency (RF) signals into digital packets and vice versa. Until Open RAN, the RAN was a monolithic system bought from a single vendor and not very flexible. Thus, O-RAN enables multiple vendors to be employed in parallel.

Open RAN architecture enables use of virtualization to disaggregate a standard RAN into several systems that run on COTS servers and are connected by open networking interfaces. Open RAN solutions are set apart by the following features: Virtualization / containerization, Disaggregation, Open Interfaces, and Automation. Regarding the Virtualization/containerization, Open RAN architecture replaces the need for proprietary hardware by virtualizing RAN functions so they can run on x86-based COTS servers. This dramatically reduces the cost and increases the flexibility of the system. Open RAN ecosystem partners are shifting from virtualization to containerization to provide even better scalability. Regarding Disaggregation, the Open RAN architecture breaks the BBU into an RU, DU and CU. This enables virtualization of the DU and CU, cost-effective deployment and management, and a proven approach to Open RAN security for cloud-native networks. Open RAN also disaggregates the system hardware from the system software, which enables components from different vendors to be able to be used together.

Regarding Open Interfaces, in some embodiments, there are 11 different interfaces within the RAN. The Open RAN architecture provides industry-wide standards for RAN interfaces, as defined by O-RAN ALLIANCE, that support interoperation between vendors, thereby allowing for a diverse Open RAN ecosystem. Finally, regarding the concept of automation, Open RAN architecture enables interoperation with edge cloud platform providers for advanced configuration, deployment and life cycle management. Additionally, zero-touch deployment is a requirement of Open RAN for managing a network composed of many thousands of small cell base stations.

In one or more embodiments, an O-RAN network may be implemented that includes an RU (Radio Unit), which is deployed on towers and a DU (Distributed Unit), which controls the RU. These units interface with the Centralized Unit (CU), which is hosted in the BEDC at the Local Zone. These combined pieces provide a full RAN solution that handles all radio level control and subscriber data traffic.

Referring again to FIG. 1, this figure illustrates a context diagram of an environment for a system converting a fixed wired device into a virtual wireless device using an eSIM proxy device, in accordance with embodiments described herein. A given area 100 will mostly be covered by two or more mobile network operators'wireless networks. Generally, mobile network operators have some roaming agreements that allow users to roam from home network to partner network under certain conditions, shown in FIG. 1 as home network coverage area 102 and roaming partner network coverage area 104. Operators may configure the mobile user's device, referred to herein as user equipment (UE), such as UE 106, with priority and a timer to stay on the home network coverage area 102 versus the roaming partner network coverage area 104. If a UE (e.g., UE 106) cannot find the home network coverage area 102, the UE will scan for a roaming network after a timer expiration (6 minutes, for example). If a UE (e.g., UE 106) cannot find the home network coverage area 102, the UE will be transferred to a partner roaming network in the roaming partner coverage area 104.

As shown in FIG. 1, a RAN is split into DUs (e.g., DU 108) that manage scheduling of all the users and a CU (CU-CP, CU-UP) 110 that manages the mobility and radio resource control (RRC) state for all the UEs 106. The RRC is a layer within the NR protocol stack. It exists only in the control plane, in the UE 106 and in the gNB. The behavior and functions of RRC are governed by the current state of RRC. In 5G NR, RRC has three distinct states: RRC_IDLE, RRC_CONNECTED and RRC_INACTIVE. Additionally, the CU (CU-CP, CU-UP) 110 further connects all the UEs 106 to the 5G Core 130.

FIG. 2 illustrates a diagram of an example system architecture overview 200 of a system for implementing parallel software instances in O-RAN in a cellular network in which the environment of FIG. 1 may be implemented in accordance with embodiments described herein. As shown in FIG. 2, the radio unit (RU) 206 converts radio signals sent to and from the antenna into a digital signal for transmission over packet networks. It handles the digital front end (DFE) and the lower physical (PHY) layer, as well as the digital beamforming functionality.

The DU 204 may sit close to the RU 206 and runs the radio link control (RLC), the Medium Access Control (MAC) sublayer of the 5G NR protocol stack, and parts of the PHY layer. The MAC sublayer interfaces to the RLC sublayer from above and to the PHY layer from below. The MAC sublayer maps information between logical and transport channels. Logical channels are about the type of information carried whereas transport channels are about how such information is carried.

The CU 202 is the centralized unit that runs the RRC and Packet Data Convergence Protocol (PDCP) layers. A RAN may comprise a CU and one DU connected to the CU via F1-C and F1-U interfaces for control plane (CP) and user plane (UP), respectively. A CU with multiple DUs will support multiple RAN. The split architecture enables a 5G network to utilize different distribution of protocol stacks between CU 202 and DU 204 depending on midhaul availability and network design. The CU 202 is a logical node that includes the RAN functions like transfer of user data, mobility control, RAN sharing, positioning, session management, etc., with the exception of functions that may be allocated exclusively to the DU 204. The CU 202 controls the operation of several DUs 204 over the mid-haul interface.

As shown in FIG. 2, the DU's server and relevant software may be hosted on a cell site 216 itself or can be hosted in an edge cloud (local data center (LDC) 218 or central office) depending on transport availability and fronthaul interface. The CU's server and relevant software may be hosted in a regional cloud data center or, as shown in FIG. 2, in a breakout edge data center (B-EDC) 214. The DU 204 may be provisioned to communicate via a pass-through edge data center (P-EDC) 208. The P-EDC 208 may provide a direct circuit fiber connection from the DU directly to the primary cloud availability zone (e.g., B-EDC 214) hosting the CU 202. In some embodiments, the LDC 218 and P-EDC 208 may be co-located or in a single location. The CU 202 may be connected to a regional cloud data center (RDC) 210, which in turn may be connected to a national cloud data center (NDC) 212. In the example embodiment, the P-EDC 208, the LDC 218, the cell site 216 and the RU 206 may all be managed by the mobile network operator and the B-EDC 214, the RDC 210 and the NDC 212 may all be managed by a cloud computing service provider. According to various embodiments, the actual split between DU and RU may be different depending on the specific use-case and implementation.

In some embodiments, the network architecture utilizes a logical hierarchical architecture consisting of National Data Centers (NDCs), Regional Data Centers (RDCs) and Breakout Edge Data Centers (BEDCs), to accommodate the distributed nature of 5G functions and the varying requirements for service layer integration. In one or more embodiments, BEDCs are deployed in Local Zones hosting 5G NFs that have strict latency budgets. They may also be connected with Pass-through Edge Data Centers (PEDC), which serve as an aggregation point for all Local Data Centers (LDCs) and cell sites in a particular market. BEDCs also provide Internet peering for 5G data service.

In one or more embodiments, an O-RAN network may be implemented that includes an RU (Radio Unit), which is deployed on towers and a DU (Distributed Unit), which controls the RU. These units interface with the Centralized Unit (CU), which is hosted in the BEDC at the Local Zone. These combined pieces provide a full RAN solution that handles all radio level control and subscriber data traffic. In some embodiments, the User Plane Function (Data Network Name (DNN)) is collocated in the BEDC, which anchors user data sessions and routes to the Internet. In another aspect, the BEDCs leverage local Internet access available in Local Zones, which allows for a better user experience while optimizing network traffic utilization.

In one or more embodiments, the Regional Data Centers (RDCs) are hosted in the Region across multiple availability zones. The RDCs host 5G subscribers'signaling processes such as authentication and session management as well as voice for 5G subscribers. These workloads can operate with relatively high latencies, which allows for a centralized deployment throughout a region, resulting in cost efficiency and resiliency. For high availability, multiple RDCs are deployed in a region, each in a separate Availability Zone (AZ) to ensure application resiliency and high availability.

In another aspect of some embodiments, an AZ is one or more discrete data centers with redundant power, networking, and connectivity in a Region. In some embodiments, AZs in a Region are interconnected with high-bandwidth and low-latency networking over a fully redundant, dedicated metro fiber, which provides high-throughput, low-latency networking between AZs. Cloud Native Functions (CNFs) deployed in the RDC utilize a high speed backbone to failover between AZs for application resiliency. CNFs like AMF and SMF, which are deployed in RDC, continue to be accessible from the BEDC in the Local Zone in case of an AZ failure. They serve as the backup CNF in the neighboring AZ and would take over and service the requests from the BEDC.

In this embodiment of the System for a Fixed Wired Connection To A Wireless Core via an e-SIM Proxy Device, dedicated VPCs are implemented for each Data Center type (e.g., local data center, breakout edge data center, regional data center, national data center, and the like). In some such embodiments, the national data center VPC stretches across multiple Availability Zones (AZs). In another aspect of some embodiments, two or more AZs are implemented per region of the cloud computing service provider. Some embodiments of the 5G Core network functions require support for advanced routing capabilities inside VPC and across VPCs (e.g., UPF, SMF and ePDG). These functions rely on routing protocols such as BGP for route exchange and fast failover (both stateful and stateless). To support these requirements, virtual routers are deployed on EC2 to provide connectivity within and across VPCs, as well as back to the on-prem network.

FIG. 3 is a diagram showing connectivity between certain telecommunication network components with respect to a system (e.g., a system for implementing parallel software instances in O-RAN in a cellular network). The central unit control plane (CU-CP) 302, for example, of CU 110 of FIG. 1 or CU 202 of FIG. 2, primarily manages control processing of DUs, such as DU 308, and UEs, such as UE 306. The CU-CP 302 hosts RRC and the control-plane part of the PDCP protocol. CU-CP 302 manages the mobility and radio resource control (RRC) state for all the UEs. The RRC is a layer within the NR protocol stack and manages context and mobility for all UEs. The behavior and functions of RRC are governed by the current state of RRC. RRC has three distinct states: RRC_IDLE, RRC_CONNECTED and RRC_INACTIVE. The CU-CP 302 terminates the E1 interface connected with the central unit user plane (CU-UP) 304 and the F1-C interface connected with the DU 308. The DU 308 maintains a constant heartbeat with CU-CP 302. The CU-UP 304 manages the data sessions for all UEs 306 and hosts the user plane part of the PDCP protocol. The CU-UP 304 terminates the E1 interface connected with the CU-CP and the F1-U interface connected with the DU 308. Additionally, the CU-CP 302 and the CU-UP 304 further each connect to the 5G Core 330.

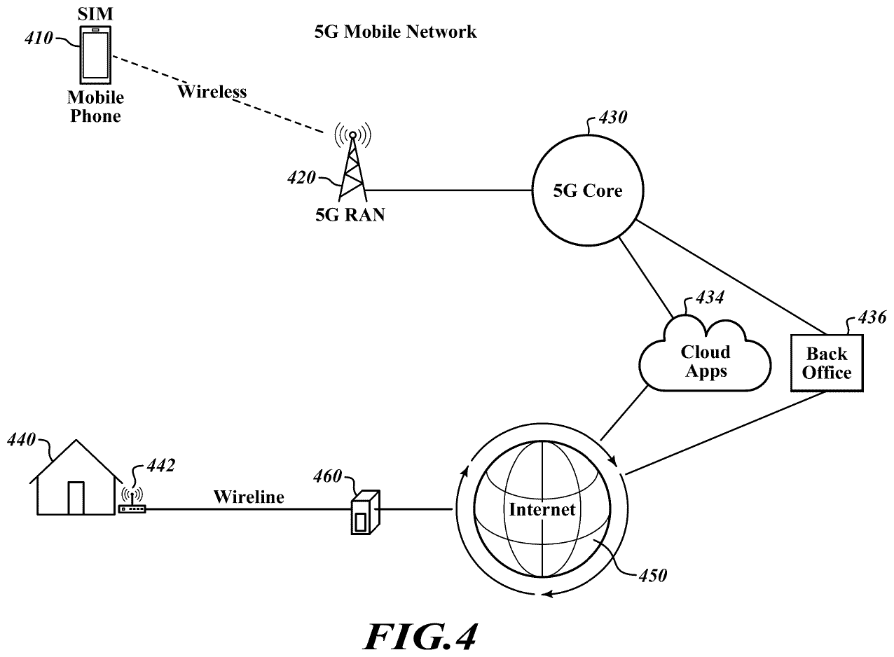

Referring now to FIG. 4, a legacy system for a fixed wire connected user devices to the Internet is shown. Currently, 5G end user devices 410 with SIM cards (or eSIMs) connect through a radio tower 420 to a 5G Core 430 (i.e., 5G network 430). The 5G Core 430 of FIG. 4 is analogous to the 5G Core 130 of FIG. 1 and the 5G Core 330 of FIG. 3. The radio tower 420 may be a satellite or an antenna. The radio tower 420. The radio tower 420 may be a satellite or an antenna. The radio tower 420. The radio tower 420 may be a satellite or an antenna. The radio tower 420 is the entrance into the 5G network. This connection provides natural 5G services on the 5G traffic of end user devices 410, such as end-to-end encryption, SIM orchestration, geographical restrictions, slice management, and the like. Through the 5G Core 430, 5G end user devices 410 are able to connect to cloud-based assets, such as cloud based applications 434 and secure back office datacenters 436.

In such a legacy system, fixed wired user devices 440, for example, desktop computers 440 in an enterprise (corporate) network (each having IP addresses 442) connect to the Internet 450 via a Domain Name System (DNS) server 460. This connection of the desktop computers 440 in an enterprise (corporate) network to the Internet 450 does not provide the same native 5G benefits (e.g., security, end-to-end encryption, etc.) as the 5G traffic of end user devices 410 to the 5G Core 430. Thus, there is a technological problem to overcome of how to cause fixed wired user devices 440 to perform as if they are 5G end user devices 410 on a 5G network 430 with native 5G features and functionality (e.g., security, end-to-end encryption, etc.).

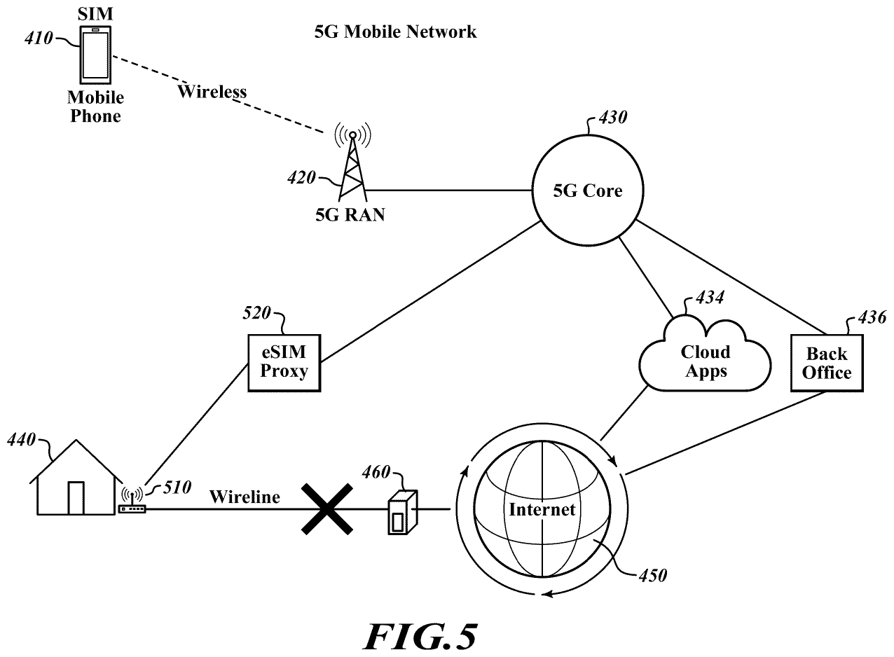

Referring now to FIG. 5, a system for a fixed wired connection of an end user device to a wireless core via an e-SIM proxy device in shown. As shown in FIG. 5, the DIA fixed wired connected, Internet-based user devices 440 (e.g., desktop computers 440) in an enterprise network are plugged into virtual eSIM proxy devices 520. The virtual eSIM proxy devices 520 create virtual eSIMs 510 (in contrast to a physical SIM cards) for every enterprise fixed wired user device 440 in the enterprise network. The virtual eSIM proxy devices 520 convert the fixed IP addresses 442 (shown in FIG. 4) of the fixed wired desktop computers 440 into the virtual eSIMs 510. The virtual eSIMs 510 are then registered with the 5G Core 430. This enables the virtual eSIM-enabled fixed wired user devices 440 to be routed into the 5G network 430 as if they were 5G mobile end user devices 410.

Thus, the virtual eSIM proxy device 520 of the system coverts the IP address 442 (shown in FIG. 4) of a desktop computer 440 into a virtual eSIM 510 that is registered on the 5G network 430, and the 5G network treats the desktop computer 440 like a 5G user end device 410 that came in over a radio network 420. In this embodiment, a user receives the same 5G service and function experience regardless of whether they connect via their 5G mobile end user device 410 while in their automobile or if they connect via their desktop computer 440 and a virtual eSIM proxy device 520 with a converted virtual eSIM 510 while the user is sitting in their office within an enterprise network. In this latter embodiment, the virtual eSIM 510 is mapped on top of the desktop computer 440 in the enterprise network to provide the same properties as the 5G network 430.

All fixed wired end user devices 410 may now be routed through 5G slices, and not the unsecure public internet 450. Thus, this system for a fixed wired connection to a wireless core via an e-SIM proxy makes the default network transmission medium a 5G network slice, rather than the Internet 450. Therefore, when an authorized user of a fixed wired user device 440 with a virtual e-SIM proxy device 520 connects to the 5G network 430, they are immediately routed to a 5G security center where they are provided with all of the appropriately configured 5G service functionality (e.g., security, encryption, etc.). The 5G security center, which is native to the 5G network 430, orchestrates all of the 5G functionality, e.g., geographical restrictions, security, encryption, low latency, etc., associated with that 5G network slice, as if the virtual eSIM-enabled desktop computer 440 was a 5G mobile phone 410 or a 5G enabled laptop. This enables native 5G functionality like zero trust, application encryption, per device policy (e.g., requiring biometrics), non-mutable ID (i.e., tying a user to a device), to come automatically to the virtual eSIM-enabled desktop computer 440. In one embodiment, there may be thirty potential 5G service functions, and the user's associated 5G slice is customizable to include only the security or other functions that are designated for that user 5G network slice.

Accordingly, no “bolted-on” extra security features are needed in the 5G network slice of the virtual eSIM-enabled desktop computer 440 (which includes native security), as was needed when the virtual eSIM-enabled desktop computer used its fixed wired connection to the Internet for sending and receiving traffic. Accordingly, “bolt-on” security infrastructure from an enterprise (corporate) network may be eliminated, since these same features are provided natively through the 5G network slice. Otherwise stated, 5G security features are overlaid onto the virtual eSIM-enabled desktop computers in the enterprise (corporate) network.

In some embodiments of the system for enabling a fixed wired connection to a wireless core via an e-SIM proxy, a virtual eSIM 510 is created for every fixed wire device user 440. Specifically, a virtual eSIM 510 is created for every fixed wired user device 440, such as a desktop computer 440, by converting the IP addresses 442 of the fixed wired user devices 440 into virtual eSIMs 510. In one or more embodiments of the system, when a fixed wired user device 440 is connected to a 5G (or higher) network 430 via a virtual eSIM proxy device 520, the following operations are executed: (1) Plug the fixed wired user device 440 into a virtual eSIM proxy device 520 that converts the IP address 442 of the fixed wired user device 440 into a virtual eSIM 510; (2) Register the virtual eSIM 510 with the 5G network 430 using its original IP address 442 (or other device ID in other embodiments); (3) Route the virtual eSIM-enabled fixed wired user device 440 into the 5G network 430 as if it is a 5G mobile wireless end user device 410; and (4) Orchestrate native 5G features (e.g., security, encryption, low latency, geo-restrictions, etc.) on the virtual eSIM-enabled fixed wired user device 440 that are normally native for a 5G end user device 410. In this manner, an enterprise network full of fixed wired user devices 440 can create virtual eSIMs 510 for the IP address 442 of every fixed wired user device 440, which can be routed on a 5G network 430 like the fixed wired user devices 440 are all 5G mobile end user devices 410.

In another embodiment of the system for enabling a fixed wired connection to a wireless core via an e-SIM proxy, a 5G service functionality that is provided by the 5G security center of the virtual eSIM-enabled fixed wired user device 440 is secure remote access to a back office datacenter 436 via the virtual eSIM proxy device 520 and the 5G Core 430. Thus, a virtual eSIM-enabled fixed wired user device 440 can be authenticated into the 5G network 430 through his security slice and then be connected directly into the back office datacenter 436 of the company, without even interacting with the Internet 450. This architecture provides significant security benefits due to the lack of interaction with the unsecure public internet 450. This may be accomplished without the use of a VPN since native 5G network slice protection is providing end-to-end encryption and there is no traffic being sent over the Internet 450.

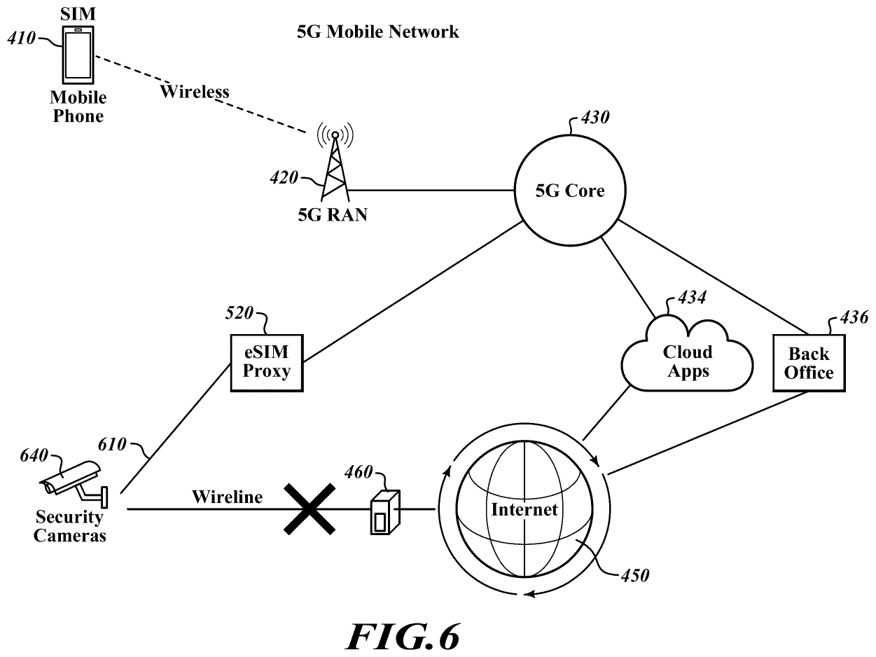

Referring now to FIG. 6, a system for a fixed wired connection of a non-user device to a wireless core via an e-SIM proxy is shown. In some embodiments shown in FIG. 6, the fixed wired connections are to non-user devices 640, such as IoT devices 640 (e.g., sensors, electric vehicles, security cameras, windmills, smart lights, traffic lights, windmills, oil riggs, pallet jacks, etc.), rather than the fixed wired user devices (e.g., desktop computer devices). In one embodiment, all stoplights for a city may be 5G-enabled IP-specific (registered) IoT devices 640 that connect to a 5G network 430. For these IoT devices 640, their Integrated Circuit Code Identification (ICC ID) number is used to connect these devices, via a virtual eSIM proxy device 520, to the 5G network 430. These IoT devices 640 connect to the virtual e-SIM proxy device 520, present their ICC ID number to the virtual e-SIM proxy device 520, and request a virtual e-SIM 610 from the virtual eSIM proxy device 520. The IoT devices 640 then receive their virtual e-SIM 610 from the virtual eSIM proxy devices 520, and become authorized users on the 5G network 430.

Once again, this system for a fixed wired connection of a non-user device to a wireless core via an e-SIM proxy makes the default network transmission medium a 5G network slice, rather than the Internet 450. In this manner, when an authorized fixed wired non-user IoT device 640 with a virtual e-SIM 610 connects to the 5G network 430, it is immediately routed to a 5G security center where it is provided with all of the appropriately configured 5G service functionality. Since these IoT devices 640 are being routed over a 5G network slice (rather than the unsecure Internet), IoT profile security can be used that is native to the 5G network protocol so that only IoT traffic can travel access the 5G network slice that is a trusted protocol, thereby preventing malicious attacks from users or systems that are transmitting data that is not IoT traffic from the 5G network slice, and not a trusted protocol.

In one embodiment of the system for a fixed wired connection to a wireless core via an e-SIM proxy, one or more pallet jack automated robots are converted from being IoT devices 640, which use Internet 450 transmissions, to virtual eSIM-enabled IoT devices 640 that use 5G network slice transmissions, via a virtual e-SIM 610 and a virtual e-SIM proxy device 520. Thus, these converted virtual eSIM-enabled IoT devices 640 are now enabled with 5G native functionality, such as security functions, that are associated with their 5G network slice parameters. In this manner, the IoT profile of these virtual eSIM-enabled IoT devices 640 can be configured to only enable access from approved IoT transmissions from the 5G network slice that are in a trusted protocol. Such pallet jack automated robots are programmed to executed various different duties (e.g., loading payloads, unloading payloads, moving payloads, etc.) in the warehouses in which they are used. These duties, and the paths of travel that the pallet jack automated robots traverse to execute these duties, are adjusted (to prevent collisions) as the number of pallet jack automated robots increases and/or the number of payloads to be processed increases.

As described above, since the IoT profile of these virtual eSIM-enabled pallet jack automated robots can be configured to only enable access from approved IoT transmissions from the 5G network slice, the pallet jack automated robots are prevented from receiving unauthorized instructions from a third party (e.g., from the Internet 450). Accordingly, the IoT profile of these virtual eSIM-enabled pallet jack automated robots can ensure that only authorized instructions are received and acted upon by the pallet jack automated robots. In some embodiments, the IoT profile authorization parameters are managed by the 5G security center.

Therefore, all malicious attacks can be prevented from users or systems that are transmitting data that is not IoT traffic from the 5G network slice, but instead is, for example, Internet-based transmitted data. By entering the IoT protocol requirement as a security feature for these virtual eSIM-enabled IoT devices 640, then all other communications can be rejected from devices with Internet-based transmissions. In this embodiment, the virtual eSIM-enabled IoT devices 640 have a IoT profile that protects 5G network slice traffic and rejects Internet traffic, which is insecure and subject to being hacked. In this manner, potentially malicious information can be immediately identified. In such a profile, only 5G network slice traffic (private) is allowed, and Internet based (public) traffic is rejected. This configuration may be implemented to immediately mitigate or eliminate all third party Internet-based malicious attacks on virtual eSIM-enabled IoT devices 640 (e.g., sensors, electric vehicles, security cameras, windmills, smart lights, traffic lights, windmills, oil riggs, pallet jacks, etc.) that have an IoT profile.

In such an embodiment, 5G eSIM authentication can be required on every device (e.g., 5G mobile end user devices 410 and virtual eSIM-enabled IoT devices 640) in the 5G network 430. Such a system enables 5G homogenous connectivity since all connections are made securely through a SIM (either a physical SIM or a virtual eSIM 610). The virtual eSIM 610 provides a digital certificate that can be used to establish authentication.

In other embodiments, there may be an extremely large number of fixed wired end user devices (e.g., desktop computers 440 within an enterprise network) and/or a fixed wired non-user IoT devices 640 that need to be converted to virtual eSIM devices that will connect to a 5G Core 430 via an eSIM proxy device 520. Examples of fixed wired non-user IoT devices 640 may include Electric Vehicles, EV chargers, traffic sensors, traffic lights, windmills, oil riggs, and the like. In such embodiments, a SIM orchestrator is used to bulk upload devices IDs (e.g., IP address, ICC IDs, etc.). The SIM orchestrator performs batch processing of the devices IDs and creates virtual eSIM for all of the devices in the bulk group. In some embodiments, the SIM orchestrator handles the conversion of millions of IoT devices into virtual eSIM devices that are routed natively on a 5G network with native 5G services and functionality. In this manner, a SIM orchestrator is very useful to speed the transition of Internet-based fixed wire devices to fixed wired end user devices (e.g., desktop computers 440) and/or fixed wired non-user IoT devices 640.

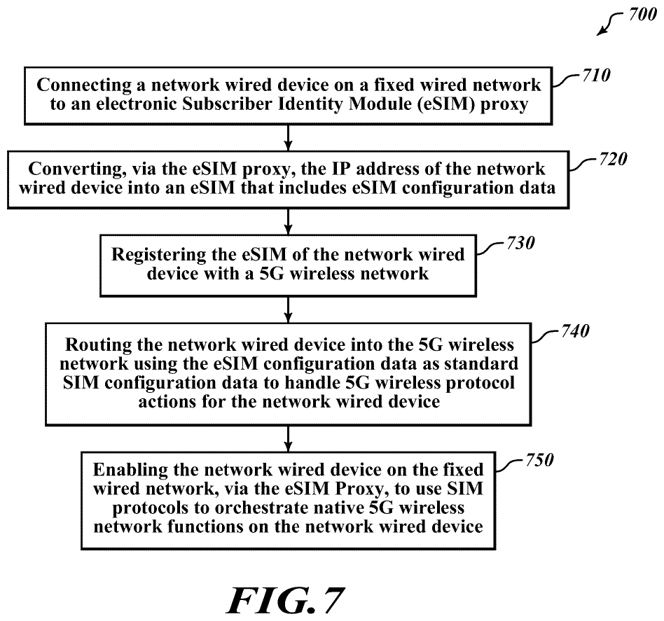

FIG. 7 is a logic diagram showing a method 700 for Fixed Wired Connection To A Wireless Core via an e-SIM Proxy. This schedule method may be implemented as a 5G architecture, such as has been shown in FIGS. 1-6 as described above. As shown in FIG. 7, at operation 710, the method includes connecting a fixed wired user device 440 on a fixed wired network to a virtual electronic Subscriber Identity Module (eSIM) proxy device 520. At operation 720, the method includes converting, via the virtual eSIM proxy device 520, the IP address 442 of the fixed wired user device 440 into a virtual eSIM 510 that includes eSIM configuration data. At operation 730, the method includes registering the virtual eSIM 510 of the fixed wired user device 440 with a 5G network 430. At operation 740, the method includes routing the fixed wired user device 440 into the 5G network 430 using the eSIM configuration data as standard SIM configuration data to handle 5G wireless protocol actions for the fixed wired user device 440. At operation 750, the method includes enabling the fixed wired user device 440 on the fixed wired network, via the virtual eSIM proxy device 520, to use SIM protocols to orchestrate native 5G wireless network functions on the fixed wired user device 440.

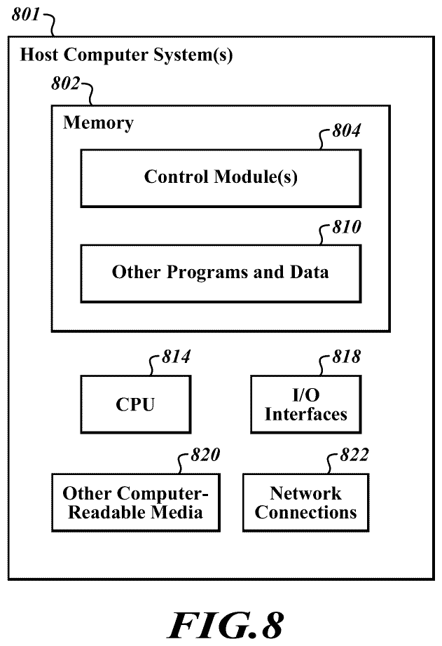

FIG. 8 shows a system diagram that describes an example implementation of a computing system(s) for implementing embodiments described herein. The functionality described herein for a system for a method for a Fixed Wired Connection To A Wireless Core via an e-SIM Proxy can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they're agnostic to the underlying cloud infrastructure, allowing higher deployment agility and flexibility. This proactive scheduling system may be implemented as a 5G architecture, such as has been shown in FIGS. 1-3 as described above.

In particular, shown is example host computer system(s) 801. For example, such computer system(s) 801 may represent those in various data centers and gNBs shown and/or described herein that host the functions, components, microservices and other aspects described herein to implement a method for a Fixed Wired Connection To A Wireless Core via an e-SIM Proxy. In some embodiments, one or more special-purpose computing systems may be used to implement the functionality described herein. Accordingly, various embodiments described herein may be implemented in software, hardware, firmware, or in some combination thereof. Host computer system(s) 801 may include memory 802, one or more central processing units (CPUs) 814, I/O interfaces 818, other computer-readable media 820, and network connections 822.

Memory 802 may include one or more various types of non-volatile and/or volatile storage technologies. Examples of memory 802 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 802 may be utilized to store information, including computer-readable instructions that are utilized by CPU 814 to perform actions, including those of embodiments described herein.

Memory 802 may have stored thereon control module(s) 804. The control module(s) 804 may be configured to implement and/or perform some or all of the functions of the systems, components and modules described herein for a method for a Fixed Wired Connection To A Wireless Core via an e-SIM Proxy. Memory 802 may also store other programs and data 810, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, and the like.

Network connections 822 are configured to communicate with other computing devices to facilitate the functionality described herein. In various embodiments, the network connections 822 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 818 may include a video interface, other data input or output interfaces, or the like. Other computer-readable media 820 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
accessing an electronic Subscriber Identity Module (eSIM) proxy device with a network wired device on a fixed Internet-based wired network, wherein the network wired device has an IP address;
converting, via the eSIM proxy device, the IP address of the network wired device into an eSIM that includes eSIM configuration data;
registering the eSIM of the network wired device with a 5G wireless network;
routing transmissions from the network wired device into the 5G wireless network using the eSIM configuration data as standard SIM configuration data to handle 5G wireless protocol actions for the network wired device; and
enabling the network wired device on the fixed wired network, via the eSIM proxy device, to use SIM protocols to orchestrate native 5G wireless network functions on the network wired device.

2. The method of claim 1, wherein orchestrating native 5G wireless network functions on the network wired device further comprises: controlling access of the Radio Access Network, via the eSIM proxy device, using SIM protocols.

3. The method of claim 1, wherein orchestrating native 5G native wireless network functions on the network wired device further comprises: controlling session encryption of the Radio Access Network, via the eSIM proxy device, using SIM protocols.

4. The method of claim 1, wherein orchestrating native 5G native wireless network functions on the network wired device further comprises: controlling mobile edge compute capability, via the eSIM proxy device, using SIM protocols.

5. The method of claim 1, wherein orchestrating native 5G native wireless network functions on the network wired device further comprises: controlling zero trust technology to provide security endpoint protection, via the eSIM proxy device, using SIM protocols.

6. The method of claim 1, wherein the orchestration of the native wireless network functions on the network wired device further includes:
enabling communication with the network wired device, via the eSIM proxy device, only over the wireless network; and
preventing Internet-based communication with the network wired device.

7. The method of claim 1, wherein the fixed wired device connects via the eSIM to a 5G network slice without connecting to a public internet, and wherein communications are secured by enabling authorized communications only through the 5G network slice, and prohibiting authorized communications outside of the 5G network slice.

8. The method of claim 1, wherein the fixed wired device is an Internet of Things (IoT) device, and wherein the IoT device is registered with an eSIM using an Integrated Circuit Card Identification (ICCID) number.

9. The method of claim 1, further comprising:
uploading device IDs of fixed wired devices in a bulk batch;
batch processing the device IDs of the fixed wired devices in the bulk batch; and
creating eSIMs for the fixed wired devices in the bulk batch.

10. A system comprising:
a memory that stores computer-executable instructions; and
a processor that executes the computer-executable instructions and causes the processor to:
access an electronic Subscriber Identity Module (eSIM) proxy device with a network wired device on a fixed wired network;
convert, via the eSIM proxy device, the IP address of the network wired device into an eSIM that includes eSIM configuration data;
register the eSIM of the network wired device with a wireless network;
route transmissions from the network wired device into the wireless network using the eSIM configuration data as standard SIM configuration data to handle wireless protocol actions for the network wired device; and
enable the network wired device on the fixed wired network, via the eSIM proxy device, to use SIM protocols to orchestrate native wireless network functions on the network wired device.

11. The system of claim 10, wherein the orchestration of the native wireless network functions on the network wired device further includes access control of the Radio Access Network, via the eSIM proxy device, using SIM protocols.

12. The system of claim 10, wherein the orchestration of the native wireless network functions on the network wired device further includes session encryption control of the Radio Access Network, via the eSIM proxy device, using SIM protocols.

13. The system of claim 10, wherein the orchestration of the native wireless network functions on the network wired device further includes mobile edge compute capability control, via the eSIM proxy device, using SIM protocols.

14. The system of claim 10, wherein the orchestration of the native wireless network functions on the network wired device further includes zero trust technology control to provide security endpoint protection, via the eSIM proxy device, using SIM protocols.

15. The system of claim 10, wherein the orchestration of the native wireless network functions on the network wired device further includes:
enabling communication with the network wired device, via the eSIM proxy device, only over the wireless network; and
preventing Internet-based communication with the network wired device.

16. The system of claim 10, wherein the fixed wired device connects via the eSIM to a network slice without connecting to a public internet, and wherein communications are secured by enabling authorized communications only through the network slice, and prohibiting authorized communications outside of the network slice.

17. The system of claim 10, wherein the fixed wired device is an Internet of Things (IoT) device, and wherein the IoT device is registered with an eSIM using an Integrated Circuit Card Identification (ICCID) number.

18. The system of claim 10, wherein the system uploads device IDs of fixed wired devices in a bulk batch, batch processes the device IDs of the fixed wired devices in the bulk batch, and creates eSIMs for the fixed wired devices in the bulk batch.

19. A non-transitory computer-readable storage medium having computer-executable instructions stored thereon that, when executed by a processor, cause the processor to:
convert, via an electronic Subscriber Identity Module (eSIM) proxy device, an IP address of a network wired device into an eSIM that includes eSIM configuration data;
register the eSIM of the network wired device with a wireless network;
route transmissions from the network wired device into the wireless network using the eSIM configuration data as standard SIM configuration data to handle wireless protocol actions for the network wired device; and
enable the network wired device on a fixed wired network, via the eSIM proxy device, to use SIM protocols to orchestrate native wireless network functions on the network wired device.

20. The non-transitory computer-readable storage medium of claim 19, wherein the orchestration of the native wireless network functions on the network wired device further includes:
enabling communication with the network wired device, via the eSIM proxy device, only over the wireless network; and
preventing Internet-based communication with the network wired device.
